(19) United States
(12) Patent Application Publication
(10) Pub. No.: US 2006/0221453 A1
(43) Pub. Date: Oct. 5, 2006

(54) Fly's eye condenser and illumination system therewith

(75) Inventors: Jess Koehler, Immenstaad (DE); Damian Fiolka, Oberkochen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/375,552

(22) Filed: Mar. 15, 2006

Related U.S. Application Data
(63) Continuation-in-part of application No. PCT/EP04/10259, filed on Sep. 14, 2004.

(30) Foreign Application Priority Data
Sep. 15, 2003 (DE) 103 44 010.0

(51) Int. Cl. G02B 27/10

(52) U.S. Cl. 359/619

(57) ABSTRACT

A fly's eye condenser (15) for converting an input light distribution into an output light distribution has at least one raster arrangement of optical groups (21, 22), of which at least some comprise polarization-changing means (30) suitable for changing polarization. The polarization-changing means include at least one layer of birefringent material associated with an optical group. The layer of birefringent material of at least two optical groups has a different thickness in a passage direction of the light. The fly's eye condenser thus permits specific, location-dependent control of the polarization state of the output light distribution. If the fly's eye condenser is used in an illumination system (10), then it can be used not only to homogenize the light distribution on the illumination plane of the illumination system but, at the same time, a location-dependent or angle-dependent polarization distribution can also be set in the illumination plane.

This application is a continuation-in-part application of international patent application PCT/EP2004/010259 filed on Sep. 14, 2004, the disclosure of which application is incorporated into the present application by reference.

### BACKGROUND OF THE INVENTION

1. Field of the Invention

The invention relates to a fly's eye condenser for converting an input light distribution into an output light distribution, having at least one raster arrangement of optical groups for producing a plurality of optical channels, and to an illumination system, in particular an illumination system for a microlithography projection exposure system, for illuminating an illumination surface with the light from a primary light source, the illumination system having at least one fly's eye condenser of the type described above.

2. Description of the Related Art

In illumination systems such as are used for example in microlithography projection exposure installations, the light from a primary light source is transmitted to an illumination surface which is shaped differently from the light source. In this case, the problem arises of illuminating this illumination surface as homogeneously as possible with the light from the light source. For this purpose, homogenizing devices are frequently used in illumination systems. Two devices which achieve such a homogenizing effect are particularly common: integrator rod arrangements and fly's eye condensers, also called fly's eye integrators.

An integrator rod arrangement substantially comprises a long rod, often with a rectangular cross section, at whose side surfaces the light entering at the end of the rod facing the light source is totally reflected many times, so that, at the rod end facing the illumination surface, the light emerges in a mixed and therefore largely homogenized form. The number of total reflections at the side surfaces of the rod depends substantially on the angle at which the light, when it enters the rod, enters in relation to these side surfaces. At each total reflection, the component of the electrical field strength vector, which is perpendicular to the plane formed by the surface normal to the reflecting surfaces and the radiation direction of the incident light, is normally reflected more intensely than is the case in the component parallel to this plane. Since the partial beams of a beam of light enter the integrator rod at different angles, the rod exerts an angle-dependent, polarization-changing effect on the entire beam, so that for example an unpolarized beam of light that enters can be partially polarized at the rod outlet side. The polarization-changing effect of the rod is caused by its design and, without additional polarization-influencing measures, may be controlled only to a small extent.

A fly's eye condenser has a raster arrangement of optical groups which produces a plurality of optical channels. The homogenizing effect in the fly's eye condenser is achieved by a large number of images of the light source (secondary light sources) being formed by the optical channels and their light then being superimposed. This superimposition leads to a certain equalization between spatial and temporal light intensity fluctuations of the light source. As opposed to an integrator rod, a fly's eye condenser usually has no polarization-changing effect caused by its function.

In order to operate a microlithography projection exposure installation, an object called a reticle is applied to the illumination surface of the illumination system and is imaged onto a wafer arranged in an image plane of the projection objective by means of a projection objective arranged downstream of the illumination system. Depending, for example, on the design of this downstream projection objective, it may be advantageous that the light distribution on the illumination surface has a specific polarization state or a specific location-dependent or angle-dependent distribution of the polarization state. For instance, it may be desired for the light distribution on the illumination surface to be unpolarized or circularly polarized. If the polarization state of the light from the primary light source is fixed, so that this cannot be influenced or influenced only with difficulty, it may thus prove to be beneficial if polarization-changing means are provided in the illumination system in order to set a specific polarization state on the illumination surface.

U.S. Pat. No. 6,257,726 B1 describes an illumination system for a projection apparatus, with which the content of an LCD display can be projected onto a wall or another flat surface. In order to achieve this, the LCD display must be illuminated with the most intense possible, linearly polarized light. The illumination system operates with a light source which provides unpolarized light. A polarization converter converts the light into linearly polarized light, largely without loss. The polarization converter has a fly's eye plate with which many identical optical channels are produced. A prism arrangement converts the unpolarized light entering into linearly polarized light, in the same way for each optical channel.

EP 0 764 858 describes an optical arrangement which transforms an entering beam of light into an emerging beam of light, in which the light is substantially radially polarized. This is achieved by a raster plate having a plurality of “honeycombs” which consist of λ/2 plates whose crystal orientations in each case differ systematically from one another and which are aligned overall in such a way that an incident, linearly polarized beam of light is converted into a cylindrically symmetrically, that is to say tangentially or radially, polarized beam of light.

### SUMMARY OF THE INVENTION

It is one object of the invention to provide a fly's eye condenser which, beyond the homogenizing effect, also exerts an additional effect on the distribution of the input light, in particular for use in an illumination system of a microlithography projection exposure installation. It is another object to provide an illumination system having such a fly's eye condenser.

To address these and other objects, the invention, according to one formulation, provides a fly's eye condenser for converting an input light distribution into an output light distribution, comprising:

at least one raster arrangement of optical groups for producing a plurality of optical channels, wherein in an optical group a field honeycomb lens and a pupil honeycomb lens are arranged one after another in a light path such that the field honeycomb lens is passed through first and the pupil honeycomb lens is passed through second in the light path, wherein at least some of the optical groups include polarization-changing means for changing the polarization state of the light passing through the optical channels; the polarization-changing means including at least one layer of birefringent material associated with at least one of at least one pupil honeycomb lens and at least one field honeycomb lens; wherein the layer of birefringent material of at least two optical groups has a different thickness in a passage direction of the light.

Advantageous developments are specified in the dependent claims. The wording of all the claims is incorporated in the content of the description by reference.

A fly's eye condenser according to one aspect of the invention for converting an input light distribution into an output light distribution has a raster arrangement of optical groups for producing a large number of optical channels. In order to influence the polarization state of the light passing through these optical channels, the fly's eye condenser has polarization-changing means in at least some of the optical groups.

A fly's eye condenser according to this aspect of the invention therefore fulfils two functions: the geometric distribution of the light entering the said condenser from the primary light source, necessary for homogenization, and also the specific influencing of the polarization state of this light as it passes through the individual optical channels. By providing a large number of optical channels for influencing the polarization, a spatial variation whose location-dependent change can be predefined more or less precisely as a function of the number of optical channels can be achieved in the polarization state in the output light distribution from the fly's eye condenser.

Advantageous in a fly's eye condenser according to this aspect of the invention is the fact that, in addition to its homogenizing property, it also has polarization-changing properties that can be specifically controlled.

In a fly's eye condenser, the optical groups frequently have a plurality of lenses. If the fly's eye condenser in one optical group has two lenses arranged one after another in the light path, then the lens that is passed through first in the light path is designated the “field lens”, the second the “pupil lens” for the purpose of this application. Due to the fact that the raster arrangement of the optical groups may resemble an array of honeycombs, one speaks of the lenses fitted in the individual channels as “honeycomb lenses”. For this reason, for the purpose of this application, the lenses of the raster arrangement which are passed through first in the light path are designated “field honeycomb lenses”, the lenses passed through second in the light path are designated “pupil honeycomb lenses”. The cross sectional shape of “honeycomb lenses” may be hexagonal, but may also differ from a hexagonal shape. For example, honeycomb lenses may have circular or rectangular shape.

If the fly's eye condenser has at least one optical group with a pupil honeycomb lens and a field honeycomb lens, and if at least one layer of birefringent material is associated with and/or applied to the pupil honeycomb lens and/or field honeycomb lens, a retardation effect can be achieved by this layer. If there is a defined, for example linear, polarization state of the light entering the birefringent layer, the polarization state of the light emerging from the layer can be set as circular, linear or elliptical polarization by means of suitable selection of the layer thickness and of the birefringent material. In addition, if appropriate by means of suitable orientation of the optical axis of the birefringent material, the polarization direction of the light passing through the layer can be changed specifically, in particular rotated. Alternatively or additionally to the layer of birefringent material, a polarization-changing stack of layers or a birefringent structure can be used for changing the polarization.

In some cases it may be difficult to manufacture the fly's eye condenser with polarization-changing means adapted for each of the optical channels separately in order to obtain a desired polarization-changing effect. In some embodiments, the polarization-changing means include at least one optical retardation element extending across a plurality of the optical channels, where a thickness of the optical retardation element in a passage direction of light varies across a cross-section of the optical retardation element such that areas of different thickness are associated with different optical channels. The optical retardation element may take the form of a plate extending across the entire useful cross-section of the fly's eye condenser covering all optical channels thereof, where the thickness of the plate varies across its cross-section. A retardation effect varying depending of the location of the optical channels can thereby be obtained.

The optical retardation element may be made from a birefringent material exhibiting linear birefringence such that light rays of linearly polarized light having orthogonal directions of oscillation of the electrical field vector have different refractive indices. The optical retardation element may also be made from an optically active material exhibiting circular birefringence in a sense that the optically active material exhibits different refractive indices for circularly polarized light rays depending on the direction of circular polarization (left-handed or right-handed circular polarization). Such material may act as a polarization rotator, where the rotation angle effected is a function of the transirradiated thickness of the material. In both cases, a desired optical retardation effect can be obtained with a minimum loss of intensity, where the amount of relative retardation of rays having different polarization states is determined by the local thickness of the material.

Optical retardation elements made from optically active crystal material are disclosed, for example, in applicant's international patent application with publication number WO 2005/069081 A2, from which further information regarding suitable optically active crystal materials and the properties of optically active crystal materials may be taken.

The variation of thickness of the plate made be stepwise or continuous. In many cases a continuous variation of thickness may be preferred since the desired spatial variation of retardation effect across the diameter of a beam transiting the fly's eye condenser may be continuous, i.e. may be smoothly varying across the cross-section.

In some embodiments the fly's eye condenser has a raster arrangement of pupil honeycomb lenses and a raster arrangement of field honeycomb lenses, defining, in combination, a plurality of optical channels, wherein the polarization-changing means include a first optical retardation element extending across a plurality of optical channels and arranged optically close to the raster arrangement of pupil honeycomb lenses and a second optical retardation element extending across a plurality of optical channels and arranged optically close to the raster arrangement of field honeycomb lenses, each of the first and second optical retardation elements having a thickness in the passage direction of light which varies across the cross-section of the optical retardation element such that areas of different thickness are assigned to different optical channels.

Using optical retardation elements of this type which can be manufactured separately from the other elements of the fly's eye condenser and which can be introduced at the appropriate position as desired allows to modify conventional fly's eye condensers to include means to influence the polarization of light transiting the fly's eye condenser with a predefined local variation of retardation effect across the used cross-section. If one optical retardation element of this type is used at the position close to a field surface and another optical retardation element is used at position close to a pupil surface it is possible to both influence the distribution of polarization states across the pupil and across the field as desired.

If a pupil honeycomb lens and/or a field honeycomb lens is produced from birefringent material, this likewise permits specific influencing of the polarization of the light passing through the optical channel. In order to achieve this polarization-influencing effect, in this case no additional optical element has to be added to the optical groups of the fly's eye condenser.

It should be pointed out at this juncture that, for the purpose of this application, light also designates radiation in the invisible wavelength range, in particular in the ultraviolet range as far as the deep UV (DUV). “Lenses” in the sense of this application can be both refractively and diffractively acting optical elements.

It may be beneficial for a plurality or all of the optical groups of the fly's eye condenser to be designed as reflective surfaces. In order to achieve a polarization-changing effect in an optical group operated in reflection as well, a layer of birefringent material can be applied to the reflective surface, being passed through twice by the light striking the optical group, since this light is reflected at the reflective surface applied to the rear side of this layer. In this case, it be must be noted that a material from which the birefringent layer is made should have a highly birefringent effect since, otherwise, the layer thicknesses necessary for influencing the polarization state effectively can become so large that an adequate light intensity is no longer let through by the layer. Such a material with a highly birefringent effect is represented by MgF₂, for example.

In a development of the fly's eye condenser, an optical group comprises a small rod of birefringent material, whose terminating surfaces are curved and therefore act as lenses. In this way, a polarization-changing, birefringent “lens” with an effective thickness of the length of the small rod is introduced. In order to achieve a polarization-changing effect, use can therefore be made of a material in which the birefringence is so small that a considerable thickness is necessary in order to achieve a noticeable retardation in fact. Such materials with a rather weak birefringent action are represented by BaF₂ or CaF₂, for example. Small rods of these materials are robust and can be produced relatively easily.

In a development of the invention, optical axes of the material which is used as a polarization-changing means have a different orientation in at least two optical groups. By this means, the polarization direction of the light passing through these optical groups is influenced differently, so that a location-dependent variation in the polarization direction can be achieved in the output light distribution from the honeycomb condenser.

If the material of at least two optical groups used as polarization-changing means in the fly's eye condenser has a different thickness, this permits a retardation effect which depends on the optical channel. This permits a setting of a location-dependent variation in the polarization state in the output light distribution from the fly's eye condenser.

In a development of the fly's eye condenser according to the invention, at least one optical group has an optical element made of stress-birefringent material, and a stressing device is provided in order to set the optical properties of this material. In this case, the polarization distribution can be controlled specifically by means of stressing by external mechanical action on the stress-birefringent material. If necessary, such control is also possible during operation, that is to say while illuminating light is passing through the fly's eye condenser, so that it is possible to react to external influences which occur and which possibly make a change in the polarization state necessary.

In a refinement of the development described above of the fly's eye condenser according to the invention, in order to arrange the optical groups in a raster, use is made of at least one carrier grid which comprises at least one wedge acting as a stressing element in order to exert a mechanical force on at least one stress-birefringent optical element. As a result, the stress-birefringent material can change its optical properties as a result of mechanical pressure from outside, which is exerted by the wedge, so that the retardation effect and, if appropriate, also the polarization-rotating effect of the optical element can be influenced specifically from outside.

If the birefringent material used as polarization-changing means consists of CaF₂ or BaF₂, then this exhibits intrinsic birefringence, given suitable orientation of its crystallographic axes. For this purpose, for example, a <110> direction of the crystal can be oriented substantially parallel to the transillumination direction. It is therefore possible, by producing birefringent lenses or small rods of suitable thickness which consist of these materials, to change the polarization state of the light passing through the birefringent material noticeably. The thicknesses to be used in this case lie in a range which makes it possible to construct a fly's eye condenser or transparent components of the same from these materials without the said condenser exceeding an overall size which is to the detriment of practical handling or incorporation in the illumination system of a microlithography projection exposure installation.

If, for the purpose of the polarization change, the birefringent material used is MgF₂, then the thicknesses in which a usable polarization-changing effect occurs are much lower than in the case of CaF₂ or BaF₂. This is because MgF₂ exhibits much higher intrinsic birefringence than the other two materials. The use of thin layers of MgF₂ can be expedient in particular if the absorption by the birefringent material plays a critical role.

A fly's eye condenser whose polarization-changing means change the polarization state in some of the optical channels in such a way that the polarization change is distributed irregularly or statistically over the large number of optical channels can be used for the purpose of achieving a depolarizing effect on the light passing through the fly's eye condenser.

If the fly's eye condenser is to have a depolarizing effect, it proves to be beneficial to use MgF₂ or other materials with a highly birefringent effect for the production of the lenses or small rods, in order to achieve a statistical polarization distribution. The fact that the light path through the individual optical channels of the fly's eye condenser is usually not equally long can lead to the effect, when MgF₂ is used, that, because of these small differences, a retardation effect occurs which differs noticeably from channel to channel. It should be recalled once more here that the layer thickness for a λ/2 retardation element for a wavelength of 157 nm is around 5 μm. If use is made in the fly's eye condenser of honeycomb lenses which are produced from MgF₂, it may prove to be beneficial to introduce differences in the lens thicknesses in the region of about 1 μm during production, which can lead to an additional depolarizing effect on the light distribution.

The invention also relates to an illumination system, in particular an illumination system for a microlithography exposure system, which can be used for illuminating an illumination surface with the light from a primary light source and has a fly's eye condenser according to the invention. In such an illumination device, by means of suitably influencing the polarization change in the individual optical channels of the fly's eye condenser, a predefined polarization distribution can be set on the illumination surface.

If, in the light path downstream of the fly's eye condenser, a first optical device for superimposing the light emerging at each individual optical channel is arranged in a first plane of the illumination system located downstream of this optical device, then this is used to fulfil the function of the fly's eye condenser as a homogenizing device for the illuminating light. This homogenizing effect is achieved by the at least partial superimposition of the light coming from the individual optical channels of the honeycomb condenser in the first plane. Usually, the light distribution produced in the first plane is projected onto the illumination surface of the illumination system by means of a suitable projection objective located downstream of the plane.

The polarization-changing effect of the fly's eye condenser is manifested in the first plane in the pupil, that is to say in the angular distribution that can be observed at an arbitrary field point of the first plane. The polarization distribution that can be observed in this angular distribution coincides with the location-dependent polarization distribution produced by the optical channels. By means of superimposing the individual channels on the first plane, on the other hand, no unambiguous assignment of polarization states can be made in the location distribution. If the first plane is projected onto the illumination surface of the illumination system by a polarization-maintaining projection objective, then the light distribution on the illumination surface therefore has an angle-dependent polarization distribution which is determined by the location-dependent polarization distribution that is set in the optical channels of the fly's eye condenser.

If, in the abovedescribed development of the invention, downstream of the first plane in which the light coming from the fly's eye condenser is superimposed, there is arranged a second optical device which transmits the light distribution in the first plane to a second plane located downstream of the second optical device, and if the light distribution in the first plane and the light distribution in the second plane can substantially be mapped on one another by means of a Fourier transform, then in this second plane the roles of the angular distribution and of the location distribution are interchanged as compared with the first plane.

A polarization distribution in the first plane observed in the pupil, that is to say in the angular distribution, is therefore converted by the second optical device into a location-dependent polarization distribution in the second plane. By projecting the second plane onto the illumination surface of the illumination system, a location-dependent polarization distribution can therefore be set on the said illumination surface.

If a diffuser plate or another diffusing element is fitted in the first plane or in the vicinity of the first plane, then, given suitable selection of the diffusing effect, this leads to its being possible for gaps possibly produced in the angular distribution in the first plane to be closed. If a second optical device is used for transmitting the angular distribution in the first plane to a location distribution in the second plane, a virtually homogeneous field distribution of the light can be achieved in the latter as a result.

In a further embodiment, an unpolarized light distribution is produced on the illumination surface of the illumination system. Unpolarized light is understood to mean light which has a largely statistical mixture of polarization states. The unpolarized light distribution on the illumination surface of the illumination system is to be achieved in this case without its mattering what polarization state the light entering the illumination system and generated by the primary light source has. This can be achieved by the fly's eye condenser having a distribution of the polarization change which is irregular over a large number of optical channels.

In a development of the illumination system according to the invention, the primary light source is a laser. The latter emits substantially linearly polarized light, which is injected into the illumination system. The linear polarization can be converted by the fly's eye condenser according to the invention into an arbitrary location-dependent or angle-dependent polarization distribution. With the aid of the fly's eye condenser, it is, for example, possible to convert the linear polarization state of the light entering the illumination system into unpolarized light on the illumination surface. In such a case, the fly's eye condenser is configured as a depolarizer and exerts a depolarizing effect on the linearly polarized input light produced by the laser.

The above and further features emerge from the description and the drawings as well as from the claims, it being possible for the individual features to be implemented in each case on their own or in a plurality in the form of sub-combinations in embodiments of the invention and in other fields and to represent embodiments which are advantageous and intrinsically capable of protection.

### BRIEF DESCRIPTION OF THE DRAWINGS

FIG. 1 shows a schematic longitudinal view of an illumination system having an embodiment of a fly's eye condenser according to the invention;

FIG. 2 shows a schematic illustration of an embodiment of a fly's eye condenser according to the invention in which the polarization-changing means are formed as layers of birefringent material;

FIG. 3 shows a schematic illustration of an embodiment of a fly's eye condenser according to the invention in which the polarization-changing means are formed as lenses of birefringent material;

FIG. 4 shows a schematic illustration of an embodiment of a fly's eye condenser according to the invention in which the polarization-changing means are formed as layers on rear-surface mirrors;

FIG. 5 shows a schematic illustration of an embodiment of a fly's eye condenser according to the invention in which the polarization-changing means are designed as small birefringent rods;

FIG. 6 shows a schematic illustration of an embodiment of a fly's eye condenser according to the invention in which wedges are used as stressing elements for influencing the optical properties of small stress-birefringent rods;

FIG. 7 shows three schematic illustrations of distributions of polarization states;

FIG. 8 shows a schematic illustration of an embodiment of a fly's eye condenser with a diffuser plate arranged downstream; and

FIG. 9 shows a schematic illustration of an embodiment of a fly's eye condenser with a two plate-like birefringent optical retardation elements having locally varying thickness.

### DETAILED DESCRIPTION OF THE PREFERRED EMBODIMENTS

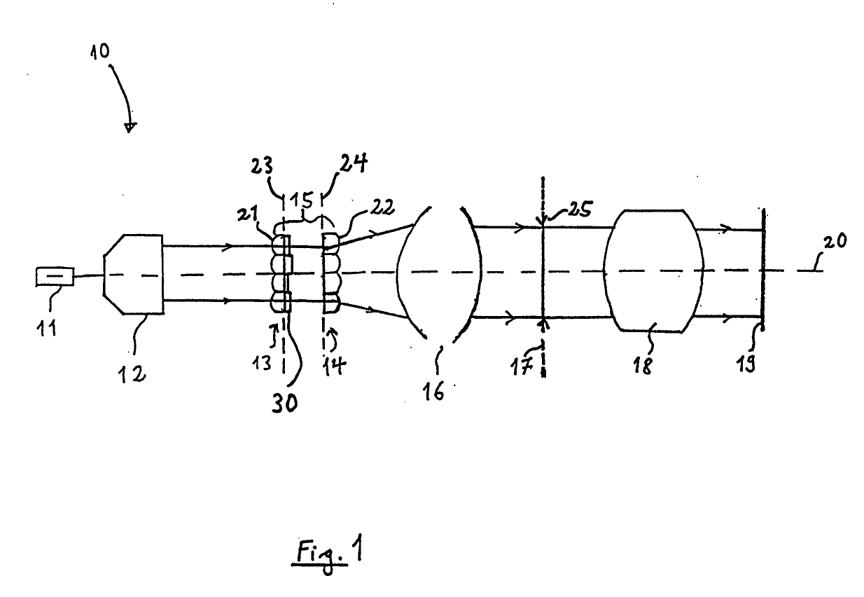

FIG. 1 shows an embodiment of an illumination system 10 of a microlithography projection exposure system, which can be used during the production of semiconductor components and other finely structured components and, in order to achieve resolutions down to fractions of micrometres, operates with light from the deep ultraviolet range. The primary light source 11 used is an F₂ excimer laser having an operating wavelength of about 157 nm, whose light beam is aligned coaxially with respect to the optical axis 20 of the illumination system. Other UV light sources, for example ArF excimer lasers with 193 nm operating wavelength, KrF excimer lasers with 248 nm operating wavelength and primary light sources with higher or lower operating wavelengths are likewise possible.

The light beam coming from the laser with a small rectangular cross section firstly strikes beam-expanding optics 12, which produce an emergent beam with largely parallel light and a larger rectangular cross section. The beam-widening optics are additionally used to reduce the coherence of the laser light.

The largely parallel light beam of linearly polarized light strikes the entry surface of a first raster arrangement 13 having first optical groups 21, which are formed as cylindrical lenses with positive, identical refractive power and rectangular cross section, the raster arrangement 13 in the example shown here being formed by an array arrangement of 4×4 cylindrical lenses whose cylinder axes are at right angles to the plane of the drawing. The rectangular shape of the cylindrical lenses 21 corresponds to the rectangular shape of the illumination field 19. The cylindrical lenses 21 are arranged immediately adjacent to one another in a rectangular grid, that is to say substantially filling the area, in or in the vicinity of a field plane 23 of the illumination system. On account of this positioning, the cylindrical lenses 21 are designated “field honeycomb lenses” or simply “field honeycombs”.

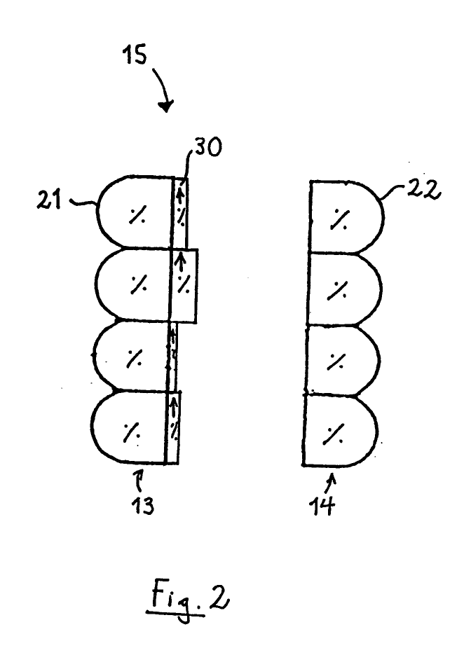

The cylindrical lenses 21 have the effect that the light incident on the plane 23 is divided up into a number of beams of light corresponding to the number of cylindrical lenses 21 that are illuminated, the said light beams being focused onto a pupil plane 24 of the illumination system 10 that lies in the focal plane of the cylindrical lenses 21. In this plane 24, or in its vicinity, there is positioned a second raster arrangement 14 having cylindrical lenses 22 of rectangular cross section and positive, identical refractive power. Each cylindrical lens (field honey comb) 21 of the first raster arrangement 13 projects the light source 11 onto a respectively associated second cylindrical lens 22 of the second raster arrangement 14, so that a large number of secondary light sources is produced in the pupil plane 24. Because of their positioning, the cylindrical lenses 22 are frequently also designated “pupil honeycomb lenses” or “pupil honeycombs” in this application. A pair of mutually associated cylindrical lenses 21, 22 of the first and of the second raster arrangement 13, 14 form an optical channel. The first raster arrangement 13 together with the second raster arrangement 14 is designated a fly's eye condenser 15 here. According to the invention, this has polarization-changing means 30, which will be described in more detail in connection with FIG. 2.

The pupil honeycomb lenses 22 are arranged in the vicinity of the respective secondary light sources and, via a field lens 16 arranged downstream, project the field honeycomb lenses 21 onto a field plane 17 of the illumination system. The rectangular images of the field honeycomb lenses 21 are superimposed in this field plane 17. This superimposition has the effect of homogenizing or evening out the light intensity in the region of this plane.

The plane 17 is an intermediate plane of the illumination system, in which a reticle/masking system (REMA) 25 is arranged, which serves as an adjustable field stop. The following objective 18 projects the intermediate plane 17 with the masking system 25 onto the reticle (the mask or the lithography original), which is located in the region of the illumination surface 19. The construction of such projection objectives 18 is known per se and will therefore not be explained in more detail here.

This illumination system 10, together with a projection objective (not shown) forms a projection exposure system for the microlithographic production of electronic components, but also of optical diffractive elements and other microstructured parts.

FIG. 2 shows the fly's eye condenser 15 from FIG. 1. The planar surfaces of the first cylindrical lenses 21 are located behind the curved surfaces of these lenses in the light passage direction, while the planar surfaces of the second cylindrical lenses 22 are located before the curved surfaces in the light passage direction. In the embodiment shown here, the field honeycomb lenses 21 have plates 30 of birefringent material of different, or varying, thickness on the planar exit surfaces. In this case, these are wrung-on plates of MgF₂ but other birefringent materials could also be used. It is likewise possible, instead of plates, to apply thin optical layers of MgF₂ or other materials to the planar surfaces of the field honeycomb lenses 21. Of course, alternatively or in addition, the pupil honeycomb lenses 22 could also have layers or plates of birefringent material.

Light which passes through the layers 30 of birefringent material can have its polarization state changed. In order to achieve a desired change in the polarization state, the layer thickness and/or the crystal orientation of the birefringent material can be selected suitably. For a detailed description of the polarization change by means of birefringence with suitable birefringent plates, reference should be made to German laid-open specification DE 101 24 803 A1 (corresponding to US 200 2 176 166) of the applicant. If use is made of laser light with a wavelength of 157 nm, the plate thickness of MgF₂ needed for a λ/2 retardation is 5.23 μm, so that effective polarization-influencing plates of this material can have a low thickness. The different retardation effect produced by the different plate thickness in the optical channels can be used for the specific, that is to say local, influencing of the polarization state. In addition, by means of different orientation of the optical axes in the individual optical channels, the polarization state can be changed specifically.

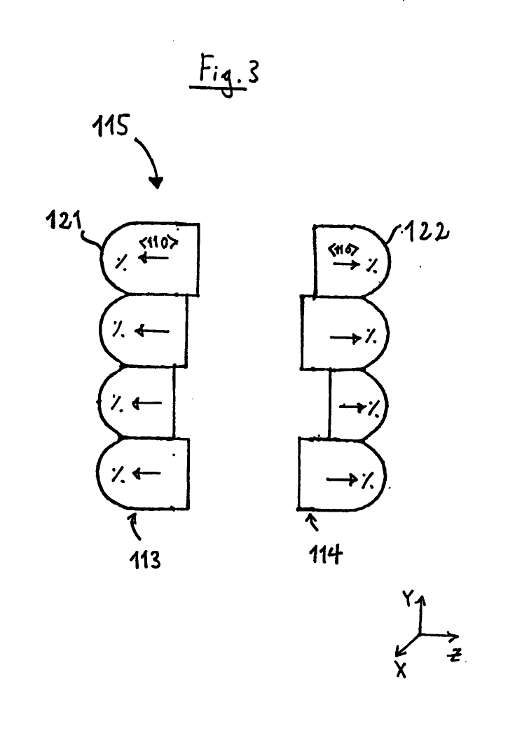

FIG. 3 shows an example of an embodiment of a fly's eye condenser 115 according to the invention having a first and a second raster arrangement 113, 114, which are composed of a 4×4 array arrangement of plano-convex cylindrical lenses 121, 122 of birefringent material. In this case, the cylindrical lenses 121, 122 have different thicknesses in the light passage direction, in order to be able to control the polarization state of the input light distribution specifically. If the wavelength of the light passing through the fly's eye condenser 115 is chosen to be 157 nm, the thickness needed for a retardation of λ/2 is 71.4 mm in the case of CaF₂ and 31.4 mm in the case of BaF₂ if the <110> crystal axis is oriented in the transillumination direction (z direction), as shown in the figure. With lens thicknesses in the region of a few centimetres, which can be managed well in terms of production, it is thus possible to set any desired retardations of the order of magnitude of the wavelength of the illuminating light.

If the desired polarization change is achieved by means of different orientation of the crystallographic axes of the individual optical channels, the thickness of the cylindrical lenses 121, 122 in the light passage direction can be equally large. Of course, the lens thickness and the orientation of the crystallographic axes of the birefringent lens material can be used jointly to achieve a polarization-changing effect.

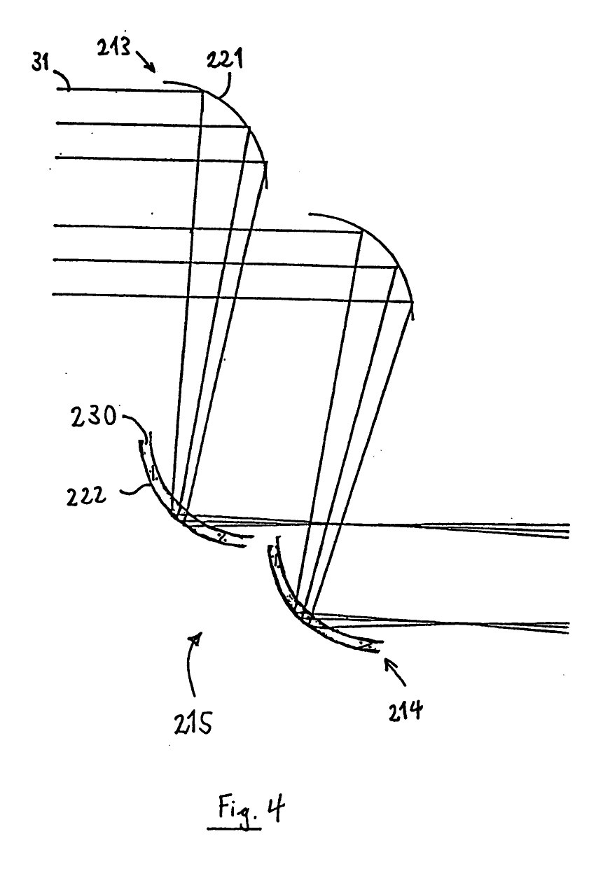

FIG. 4 shows an example of a reflective embodiment of a fly's eye condenser 215 according to the invention. It comprises a first and a second raster arrangement 213, 214, which are built up from concave mirrors 221, 222. The cylindrical mirrors 221 and 222, whose axes lie at right angles to the plane of the drawing, are in this case introduced obliquely into the beam path in each case, the first mirror 221 and the second mirror 222 of each optical channel being arranged in a plane at right angles to the optical axis. The first mirror 221 throws light entering parallel to the optical axis onto the second mirror 222, from which it is reflected substantially parallel to the optical axis. The raster arrangement is formed by the two pairs of mirrors lying in the plane of the drawing and by at least two further pairs of mirrors of identical construction, not shown here, displaced in parallel at right angles to the plane of the drawing.

All of the mirrors 221 are fitted in such a way that the light entry surface of the fly's eye condenser 215 is completely covered. Pairs of mirrors 221, 222 are in this case arranged to be offset along the optical axis in such a way that the light path from the first mirrors 221 to the second mirrors 222 remains free.

A thin layer 230 of birefringent MgF₂ is applied to each pupil honeycomb mirror 222, so that these mirrors are rear-surface mirrors. The light 31 entering the fly's eye condenser 15 is firstly reflected at the field honeycomb mirrors 221 and passes through the birefringent layer 230 before it is reflected by the pupil fly's eye mirror 222 at the rear side of the birefringent layer 230. The light passes a second time through the birefringent layer 230 before it leaves the fly's eye condenser 215 in the direction of the optical axis.

The material of which the birefringent layer 230 is composed is MgF₂ here, so that the thickness needed for an effective influence on the polarization lies in the micrometre range, and thus an excessively great reduction in the light intensity during the twofold passage of the light through the layer 230 is prevented.

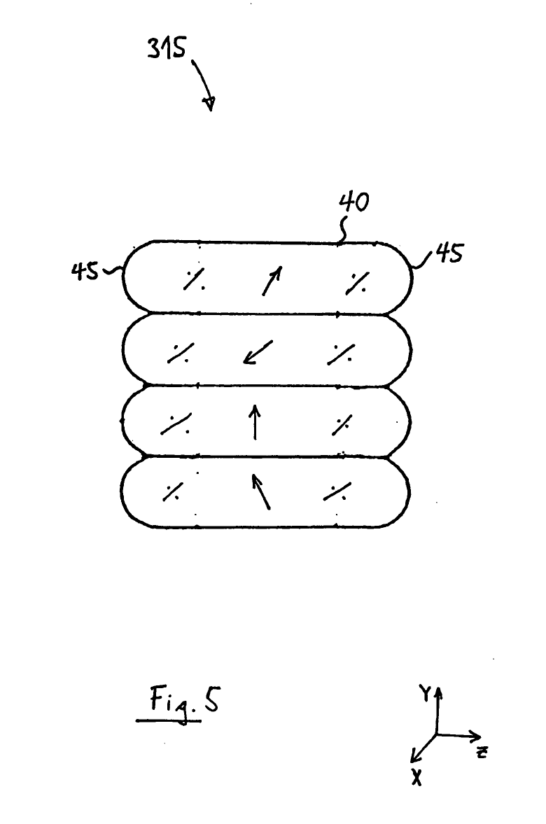

In an embodiment of a fly's eye condenser 315 according to the invention as shown in FIG. 5, it is built up with small rods 40 of birefringent material with curved terminating surfaces 45 acting as lenses. The curved terminating surfaces 45 are shaped cylindrically and long sides of the small rods 40 are aligned parallel to the light passage direction, that is to say to the z direction. In such an embodiment, the thickness of the birefringent material available for an effective influence on the polarization is increased as compared with embodiments having two separate honeycomb plates (cf. FIGS. 1-3). Such a fly's eye condenser 315 can be fabricated from a material in which the birefringence is so low that a considerable material thickness is necessary in order to achieve a noticeable retardation effect. In this case, a specific polarization-changing effect can be achieved by means of a different alignment of the crystallographic major axes of the birefringent material, illustrated in the figure by arrows. In an embodiment not shown in the figure, the length of the small rods in the z direction and thus their retardation effect can be varied.

During the passage of a beam of light through the small rod 40, differences of a few μm can occur in the light path of individual rays, so that these pass through a different thickness of birefringent material. In the event that MgF₂ with a crystal axis oriented transversely or perpendicular to the light passage direction is used, even such a small variation in the light path leads to a retardation effect of the order of magnitude of the wavelength of the light passing through the small rod 40. Therefore, individual rays of a beam of light which pass through a small rod 40 have different polarization states at the light exit side of the latter, so that the polarization state of the entire beam of light has an irregular, statistical superimposition of polarization states. Since a fly's eye condenser 315 of MgF₂ thus has a depolarizing effect in each individual optical channel, this is particularly suitable for the production of a depolarized output light distribution.

If a fly's eye condenser 315 of this type is introduced into an illumination system of a microlithography projection exposure system according to FIG. 1, then the light distribution depolarized by the fly's eye condenser 315 in the plane 17 is projected onto the illumination surface 19, so that an unpolarized light distribution is achieved in this plane, irrespective of the polarization state of the light entering the illumination system 10.

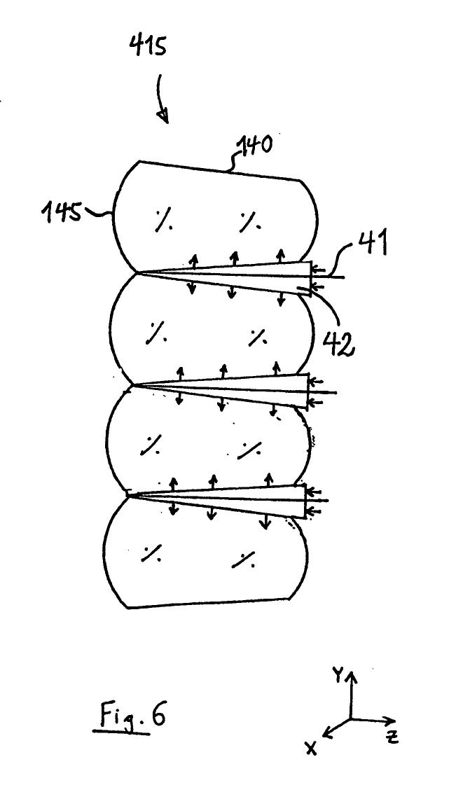

In an embodiment shown in FIG. 6, the fly's eye condenser 415 is formed of small rods 140 of stress-birefringent material having cylindrically curved terminating surfaces 145 acting as lenses, whose cylinder axis points in the x direction. The height of the small rods in the y direction in this case decreases linearly along the z direction, so that the light entry surface is covered completely by the terminating surfaces of the small rods 140 acting as lenses, but wedge-like recesses are formed with respect to the light exit surface of the fly's eye condenser 415. Wedges 42 of a stressing device are introduced into these recesses. The arrangement of wedges 42 and small rods 140 is mounted on a carrier grid 41. If a force is exerted on the wedges 142 in the z direction, this is transmitted onto the small rods 140 in the y direction and thus the stress-birefringent material is placed under stress. The polarization-changing effect can therefore be controlled specifically in each individual channel by applying different forces to the wedges 42, even while the fly's eye condenser 415 is operating. It is also possible additionally to influence the retardation effect in the individual channels by the small rods 140 having a different length in the z direction, or by the crystal axes of the small rods 140 being oriented differently.

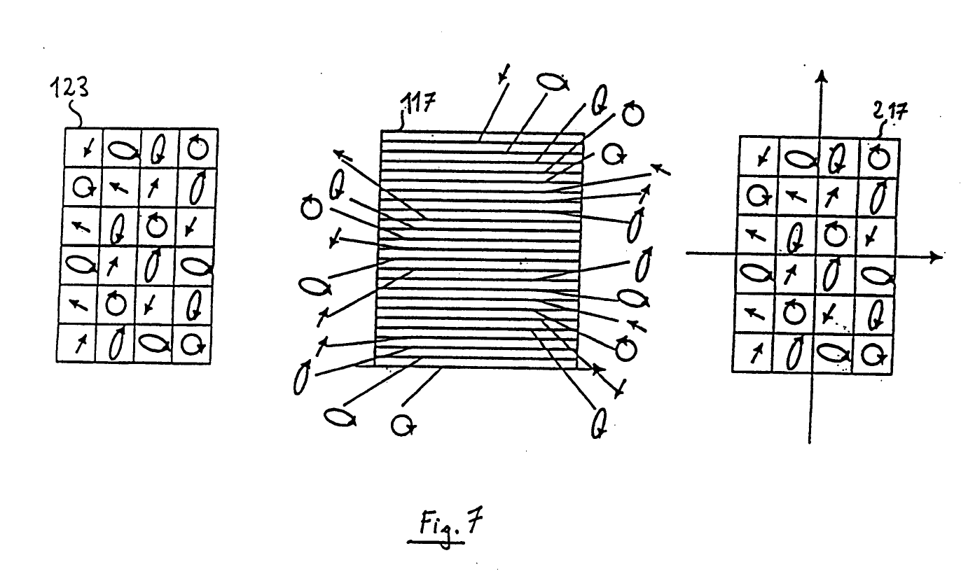

Three schematic illustrations of the distribution of polarization states are shown in FIG. 7. The left-hand part of the figure illustrates a location-dependent polarization distribution 123, such as can be set, for example, in the plane 23 downstream of the arrangement 21 shown in FIGS. 1 and 2, by means of the plates 30 of different thickness. The polarization states are in this case illustrated by arrows and by circles and ellipses, depending on whether there is linear, circular or elliptical polarization.

The central part of the image illustrates the polarization distribution 117 in the field plane 17 located downstream of the fly's eye condenser 15. Since each individual field honeycomb lens 21 is projected onto the entire field plane surface 17 by the respectively associated pupil honeycomb lens 22, superimposition of images of the field honeycomb lens occurs in this field plane surface 17. Since there is a different polarization state in each field honeycomb lens, the polarization states at every location on the field plane surface 17 are therefore also superimposed or mixed.

If an irregular, statistical polarization distribution is set with the field honeycomb lenses 21, every field point in the field plane 17 exhibits a superimposition of these statistically distributed polarization states. In this case, the fly's eye condenser 15 has a depolarizing effect on the input light.

In the right-hand part of the figure, the angular distribution 217 to be observed at every point of the field plane 17 is illustrated, having substantially the same polarization distribution as has already been illustrated in the left-hand part of the figure for the location distribution in the field plane 23. The transmission of the polarization properties of the location distribution in the field plane 23 to the angular distribution in the field plane 17 occurs since the field honeycomb lenses 21 transmit this distribution to the pupil plane 24 and the latter has a Fourier transformation relationship with the field plane 17, so that angular coordinates and location coordinates in these two planes are conjugate with one another.

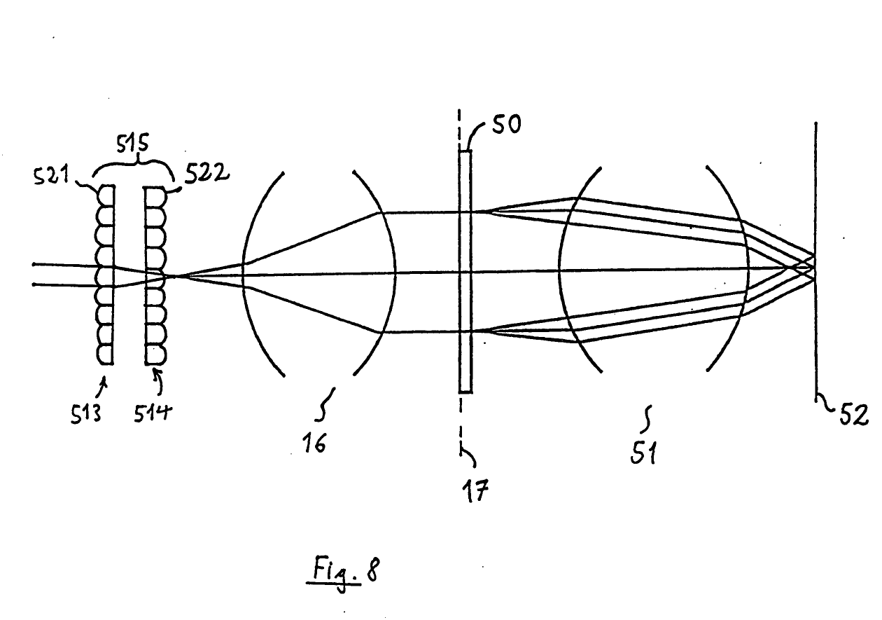

FIG. 8 shows a polarization-changing fly's eye condenser 515 having a first raster arrangement 513 and a second raster arrangement 514, which are built up from cylindrical lenses 521, 522. The structure can correspond to one of the embodiments described previously. A first optical device 16 fitted downstream of the fly's eye condenser 515 superimposes the images of the field honeycomb lenses on a plane 17 which is fitted downstream and in which a diffuser plate 50 is positioned. The light scattered at the diffuser plate 50 is transmitted by a second optical device 51 to a second plane 52 located downstream, so that there is a Fourier transformation relationship between the first plane 17 and the second plane 52.

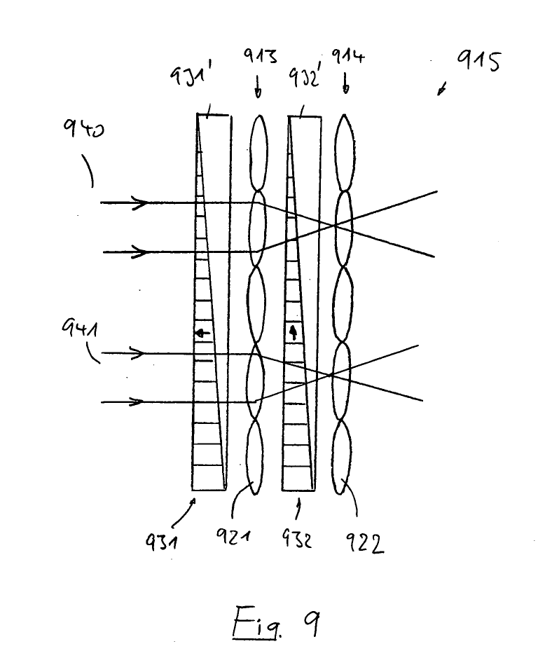

In some practical cases it may be difficult from a manufacturing point of view to apply polarization-changing means for each optical channel of a fly's eye condenser separately with a desired polarization-changing effect. For example, the diameter of the single lenses in the raster arrangements may be rather small, for example smaller than 1 mm×1 mm, which makes it difficult to apply for each channel separate polarization-changing means. In the embodiment of a fly's eye condenser 915 in FIG. 9 those difficulties are avoided. Here, the first raster arrangement 913 made of cylindrical lenses 921 (field lenses) and the second raster arrangement 914 made of cylindrical lenses 922 (pupil lenses) may be taken from a conventional fly's eye condenser with lenses, for example, made from fused silica of calcium fluoride without polarization changing means applied directly in contact to the lenses. The polarization-changing means are formed by two separate optical retardation elements 931, 932, where the first optical retardation element 931 is arranged optically close to the field lenses 921 at a position immediately upstream of the first raster arrangement 913, and a second optical retardation element 931 is arranged optically closer to the second raster arrangement 914 near the focal plane of the lenses of the first raster arrangement 913.

Each of the first and second optical retardation elements includes a solid one-part plate made from a birefringent material, where the plate extends across the entire useful cross-section of the fly's eye condenser, thereby covering all optical channels of the fly's eye condenser. The geometrical thickness of the plate of birefringent material (indicated by hatching in the figure) varies in a predefined way continuously across the cross-section of the plate, for example to provide a linear gradient of thickness across the diameter. Other thickness profiles, such as irregular thickness profiles or thickness profiles being rotationally symmetric to an optical axis of the fly's eye condenser are also possible. Such plate-like retardation element may be described as a layer of birefringent material not in physical contact with the lenses of the raster arrangement, where the layer thickness is different for each optical channel.

Each of the birefringent plates 931, 932 is fixed to a complementarily shaped compensation plate 931′, 932′ made of an optically isotropic, non-birefringent material, such as fused silica, such that the combination of the birefringent plate 931, 932 and the corresponding non-birefringent compensation plate forms a plane parallel plate. Thereby, a compensation of angular deviations caused by the birefringent plate can be effected.

The compensation plates 931′, 932′ made of non-birefringent material may be used if angular deflections caused be the retardation element are not acceptable. In other cases, a simpler construction may be obtained by avoiding the optional compensation plates for one or all of the retardation elements.

It is evident that a first partial beam 940 running through one optical channel is influenced by a smaller thickness of birefringent material than a parallel second partial beam 941 which passes through another optical channel laterally offset to the first optical channel.

The optical retardation elements 931, 932 may be manufactured independently from the fly's eye condenser to obtain the desired local variation of retardation effected by the thickness variation of the birefringent material. After manufacturing, the plates may be introduced into the fly's eye condenser and the positions may be adjusted relative thereto, to obtain the desired thickness of birefringent material in each of the optical channels.

If one of the optical retardation elements is closely associated with field lenses 921, and the other optical retardation element is arranged close to a plane Fourier-transformed thereto, it is possible to obtain, at the same time, a manipulation of the distribution of polarization states in the pupil of the optical system and across the field. For example, the first optical retardation element 931 may be designed as correction element for compensating an undesired offset of birefringent effect over the pupil, whereas the second optical retardation element 932 may be designed to correct the field dependent contributions of the perturbations. Under these conditions it is useful to place the first optical retardation element 931 associated with the field lenses 921 in a region with largely collimated radiation (small ray angles relative to the optical axis) such as in the parallel beam immediately upstream of the field lenses 921. By doing so, the polarization state distribution across the diameter of the entire beam is adjusted by variation of the transirradiated thickness of the birefringent optical retardation element 931. The lenses of the first raster arrangement 931 introduce additional ray angles, thereby increasing the geometrical light conductance value (etendue) such that the second optical retardation element 932 is transmitted by separate light bundles. The light bundles correspond to a certain field distribution in the reticle field. Each light bundle generated in an optical channel by the first raster arrangement spans the entire field in the plane of the mask to be illuminated by the illumination system (i.e. the reticle plane) since the optical channels generate fields which are superimposed in the reticle field. In this case it may be preferable that the thickness variation of the second optical retardation element is adjusted such that the retardation effect is largely dependent on the angle of the incident radiation and from the location of the optical channel within the fly's eye condenser. In a retardation element where the retardation effect is strongly dependent on the angle of the incident radiation the thickness of the plate predominantly affects the absolute value of the birefringence, i.e. the phase thereof. Using a birefringent retardation element having an retardation effect strongly dependent on the angles of incidence allows to adjust the variation of polarization states across the reticle field as desired.

A correction of undesired birefringence effects typically includes a correction for the rotation of a preferred direction of the polarization ellipse and a correction of the phases of the ellipse, for example to obtain light having essentially linear polarization in the desired direction, or having circular polarization. The arrangements schematically shown in FIG. 9 is ideally suited for that purpose. For example, the optical retardation element 931 disposed in the collimated beam may be designed as an optical rotator in order to influence the orientation of a preferred direction of polarization by adjusting the spatial thickness distribution of the retardation element accordingly. For this purpose, the optical retardation element 931 may be made from an optically active crystalline quartz material having the crystallographic optical axis (also denoted crystal axis here) of the crystalline quartz material aligned parallel to the optical axis of the fly's eye condenser (i.e. essentially parallel to the incident direction of light). With the known and predefined orientation of the preferred direction of polarization optically downstream of the first optical retardation element 931 the local variation of thickness of the second optical retardation element 932 can be selected such that the phase is varied as desired by applying appropriate local thickness areas of the material for each optical channel. For this purpose, an optically active crystalline quartz material can be used having the orientation of the crystal axis of the crystalline material oriented essentially perpendicular to the light propagation direction, i.e. essentially perpendicular to the optical axis of the fly's eye condenser. In this arrangement, the orientation as well as the phase of an undesired or desired birefringence effect may be adjusted solely by selecting the correct thickness distribution of the plates 931, 932 having different orientation of the crystal axes (arrows). Due to the large variation of angles of incidence at the second optical retardation element 932 it may be preferred to use zero order or low order retardation elements at this position.

In the cases described above, where an optically active material is used for manufacturing the optical retardation elements the term “crystal axis” of the optically active material refers to the axis of isotropy of that material, which is defined by the property that there is only one velocity of light propagation associated with the direction of the crystal axis. In other words, a light ray travelling in the direction of the crystal axis of the optically active material is not subject to a linear birefringence. If linearly polarized light traverses the optically active retardation element along the crystal axis thereof, the oscillation plane of the electrical field vector is rotated by an angle that is proportional to the distance travelled inside the crystalline material. The sense of rotation, i.e. whether the oscillation plane is rotated clockwise or counter clockwise, depends on the crystal material, for example right-handed quartz or left-handed quartz. The polarization plane is parallel to the respective directions of the polarization and the propagation of the light ray. By shaping the element with a specific thickness at each location, it is possible to obtain arbitrarily selected angles of rotation for the oscillation planes.

Different combinations of plates of optically active material are possible. For example, the crystal axis of the optically active material forming the first retardation element may be oriented parallel to the optical axis of the fly's eye condenser whereas the crystal axis of the optically active material of the second radiation element may be oriented perpendicular thereto. This situation is schematically illustrated by the arrows in FIG. 9. Alternatively, the crystal axes of the optically active materials of the first and second optical retardation element may be oriented perpendicular to the optical axis of the fly's eye condenser (i.e. the crystal axis may be oriented within the plane of the plate) but the crystal axes of the first and second optical retardation element may be oriented in non-parallel directions, e.g. in mutually orthogonal directions, thereby including an angle therebetween.

The apparatus shown here can be used in an illumination system according to FIG. 1 by the diffuser plate 50 being introduced into the plane 17 or its vicinity and by the optical device 51 being introduced into the beam path downstream thereof. The second plane 52 is then projected onto the illumination surface 19 by the objective 18 and represents an intermediate field plane. In this case, the first plane 17 is a pupil plane and the diffuser plate is used to close any gaps which may possibly be present in the angular distribution in this plane. The optical device 51 effects an interchange between location and angular coordinates in the planes 17 and 52. With the aid of this device, it is therefore possible for a location-dependent polarization distribution to be predefined on the illumination surface 19 of the illumination system 10, the same location-dependent polarization distribution substantially corresponding to the distribution of the polarization states which were set in the optical channels of the fly's eye condenser 15. In the angular distribution that can be observed at every location on the illumination surface 19, there is then a superimposition of the polarization states set in the optical channels.

Other designs of illumination systems are likewise possible. For instance, an illumination system can be constructed in the manner shown in FIG. 1 of Patent application DE 100 40 898.2 (EP 1 180 726 A2). It can comprise more than two fly's eye plates (raster arrangement of honeycomb lenses), for example four, one or more of the fly's eye plates being equipped with polarization-changing means in accordance with one or more of the possibilities described here. Depending on the position of the fly's eye condenser in the illumination system the raster arrangement having the “field honeycomb lenses” may be positioned in a pupil plane of the illumination system or in the vicinity thereof and the raster arrangement having the “pupil honeycomb lenses” may be positioned in a field plane of the illumination system or in the vicinity thereof.

Some features and advantages of the invention and its embodiments can be illustrated as follows here: a polarization-changing fly's eye condenser according to the invention permits specific, location-dependent control of the polarization state of the output light distribution. If the fly's eye condenser is used in an illumination system, then it can be used not only to homogenize the light distribution on the illumination plane of the illumination system but, at the same time, a location-dependent or angle-dependent polarization distribution can also be set in the said plane. For instance, it is possible, by using a fly's eye condenser according to the invention, to construct an illumination system which produces an unpolarized light distribution on the illumination surface, irrespective of the polarization state of the light entering the illumination system.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. Fly's eye condenser for converting an input light distribution into an output light distribution, comprising:
at least one raster arrangement of optical groups for producing a plurality of optical channels, wherein in an optical group a field honeycomb lens and a pupil honeycomb lens are arranged one after another in a light path such that the field honeycomb lens is passed through first and the pupil honeycomb lens is passed through second in the light path,
wherein at least some of the optical groups include polarization-changing means for changing the polarization state of the light passing through the optical channels;
the polarization-changing means including at least one layer of birefringent material associated with at least one of at least one pupil honeycomb lens and at least one field honeycomb lens;
wherein the layer of birefringent material of at least two optical groups has a varying thickness in a passage direction of the light.

2. Fly's eye condenser according to claim 1, wherein the layer of birefringent material is in contact with at least one of at least one pupil honeycomb lens and at least one field honeycomb lens.

3. Fly's eye condenser according to claim 1, wherein the polarization-changing means include at least one optical retardation element extending across a plurality of the optical channels, where a thickness of the optical retardation element in the passage direction of light varies across a cross-section of the optical retardation element such that areas of different thickness are associated with different optical channels to form a layer of birefringent material associated with the optical channels.

4. Fly's eye condenser according to claim 3, wherein the thickness of the retardation element varies continuously across the cross-section of the retardation element.

5. Fly's eye condenser according to claim 3, wherein the optical retardation element is made from a birefringent material exhibiting linear birefringence.

6. Fly's eye condenser according to claim 3, wherein the optical retardation element is made from an optically active crystal material exhibiting circular birefringence.

7. Fly's eye condenser according to claim 3, wherein the optical retardation element has the form of a plate extending across the entire useful cross-section of the fly's eye condenser covering all optical channels thereof, where the thickness of the plate varies across the cross-section of the plate.

8. Fly's eye condenser according to claim 1, wherein the fly's eye condenser has a raster arrangement of pupil honeycomb lenses and a raster arrangement of field honeycomb lenses, defining, in combination, a plurality of optical channels,
wherein the polarization-changing means include a first optical retardation element extending across a plurality of optical channels and arranged optically close to the raster arrangement of pupil honeycomb lenses and a second optical retardation element extending across a plurality of optical channels and arranged optically close to the raster arrangement of field honeycomb lenses,
each of the first and second optical retardation elements having a thickness in the passage direction of light which varies across the cross-section of the optical retardation element such that areas of different thickness are assigned to different optical channels.

9. Fly's eye condenser according to claim 8, wherein the first optical retardation element is made from an optically active material having a crystal axis oriented essentially parallel to an element axis of the fly's eye condenser and the second retardation element is made from an optically active material having a crystal axis oriented essentially perpendicular to the element axis of the fly's eye condenser.

10. Fly's eye condenser according to claim 8, wherein the first optical retardation element is made from an optically active material having a crystal axis oriented essentially perpendicular to the element axis of the fly's eye condenser and the second optical retardation element is made from an optically active material having a crystal axis oriented perpendicular to the element axis of the fly's eye condenser at an angle with respect to the crystal axis of the first optical retardation element.

11. Fly's eye condenser according to claim 8, wherein one of the optical retardation elements is arranged at a position close to or at a field surface and another optical retardation element is arranged at a position close to or at a pupil surface essentially Fourier transformed to the field surface.

12. Fly's eye condenser according to claim 1, wherein the birefringent material has an optical axis and wherein the birefringent materials used as polarization-changing means of at least two optical groups have respectively differing orientations.

13. Fly's eye condenser according to claim 1, wherein the birefringent material of at least one optical group used as polarization-changing means is a crystal of CaF₂ or BaF₂, wherein a crystallographic <110> direction is aligned substantially parallel to a transillumination direction of the optical groups.

14. Fly's eye condenser according to claim 1, wherein the birefringent material of at least one optical group used as polarization-changing means is MgF₂.

15. Fly's eye condenser according to claim 1, wherein the polarization-changing means are formed such that the polarization state of at least some of the optical channels is changed such that the polarization change is distributed irregularly over the plurality of optical channels, whereby a substantially depolarized output light distribution is obtained from a polarized input light distribution.

16. Fly's eye condenser according to claim 15, wherein, in some of the optical groups for which polarization-changing means are provided, MgF₂ is used as the birefringent material for producing an irregular polarization change.

17. Fly's eye condenser according to claim 1, wherein a layer thickness and the birefringent material of the layer is selected such that an output light distribution having one of a circular, linear and elliptical polarization is obtained.

18. Fly's eye condenser according to claim 1, wherein the birefringent layer is formed by one of a polarization-changing stack of single layers and a birefringent structure.

19. Fly's eye condenser according to claim 1, wherein at least one of at least one pupil honeycomb lens and at least one field honeycomb lens consists of a birefringent material.

20. Fly's eye condenser according to claim 1, wherein at least one optical group has at least one optical element of stress-birefringent material, and at least one stressing device is provided in order to at least one of set and change the optical properties of the stress-birefringent material.

21. Fly's eye condenser according to claim 20, which, in order to arrange the optical groups in a raster, comprises at least one carrier grid which has at least one wedge acting as the stressing element of the stressing device, in order to exert a mechanical force on the at least one optical element of stress-birefringent material.

22. Illumination system for illuminating an illumination surface with the light from a primary light source comprising at least one fly's eye condenser according to claim 1.

23. Illumination system according to claim 22, wherein in the light path downstream of the fly's eye condenser there is arranged a first optical device for superimposing the light emerging at each individual optical channel in a first plane of the illumination system, located downstream of the optical device.

24. Illumination system according to claim 22, wherein in the light path downstream of the first plane there is arranged a second optical device which transmits the light distribution in the first plane to the light distribution of a second plane located downstream of the second optical device such that the light distribution in the first plane and the light distribution in the second plane are substantially mapped on one another by means of a Fourier transformation.

25. Illumination system according to claim 23, wherein a diffusing element is fitted in the first plane or in the vicinity of the first plane.

26. Illumination system according to claim 22, wherein the fly's eye condenser is designed so that the polarization change is distributed irregularly over a large number of optical channels by the fly's eye condenser.

27. Fly's eye condenser for converting an input light distribution into an output light distribution, comprising:
at least one raster arrangement of optical groups for producing a plurality of optical channels, wherein in an optical group a field honeycomb lens and a pupil honeycomb lens are arranged one after another in a light path such that the field honeycomb lens is passed through first and the pupil honeycomb lens is passed through second in the light path,
wherein at least one of at least one pupil honeycomb lens and at least one field honeycomb lens consists of a birefringent material effective as polarization-changing means for changing the polarization state of the light passing through the optical channel.

28. Fly's eye condenser according to claim 27, wherein optical axes of the birefringent material used as polarization-changing means of at least two optical groups have respectively differing orientations.

29. Fly's eye condenser according to claim 27, wherein the birefringent material of at least two optical groups used as polarization-changing means has a different thickness in the passage direction of the light.

30. Fly's eye condenser according to claim 27, wherein the birefringent material of at least one optical group used as polarization-changing means is MgF₂.

31. Fly's eye condenser according to claims 27, wherein the birefringent material of at least one of a pupil honeycomb lens and a field honeycomb lens is a crystal of CaF₂ or BaF₂, wherein a crystallographic <110> direction is aligned substantially parallel to a transillumination direction of the optical group.

32. Fly's eye condenser according to claim 27, wherein the polarization-changing means are formed in such a way that they change the polarization state of at least some of the optical channels in such a way that the polarization change is distributed irregularly over the plurality of optical channels.

33. Fly's eye condenser according to claim 27, wherein at least one optical group has at least one optical element of stress-birefringent material, and at least one stressing device is provided in order to at least one of set and change the optical properties of this stress-birefringent material.

34. Fly's eye condenser according to claim 33, which, in order to arrange the optical groups in a raster arrangement, comprises at least one carrier grid which has at least one wedge acting as the stressing element of the stressing device, in order to exert a mechanical force on the at least one optical element of stress-birefringent material.

35. Fly's eye condenser according to claim 27, wherein a thickness of the birefringent material in a passage direction of light is selected such that an output light distribution having one of circular, linear and elliptical polarization is obtained.

36. Fly's eye condenser according to claim 27, wherein at least one optical group includes a rod having curved terminating surfaces acting as lens surfaces such that the rod forms a field honeycomb lens and a pupil honeycomb lens, the rod consisting of birefringent material effective as a polarization-changing means for changing the polarization state of the light passing through the optical channel.

37. Fly's eye condenser according to claims 36, wherein the birefringent material of the rod is MgF₂.

38. Fly's eye condenser according to claims 36, wherein the birefringent material of at least one rod is a crystal of CaF₂ or BaF₂, wherein a crystallographic <110> direction is aligned substantially parallel to a transillumination direction of the rod.

39. Fly's eye condenser for converting an input light distribution into an output light distribution, comprising:
at least one raster arrangement of optical groups for producing a plurality of optical channels;
wherein at least one optical group has at least one optical element of stress-birefringent material; and
a stressing device for at least one of setting and changing the optical properties of the stress-birefringent material by exerting a mechanical force on the stress-birefringent material.

40. Fly's eye condenser according to claims 39, wherein the stressing device has at least one wedge acting as a stressing element of the stressing device, in order to exert a mechanical force on the at least one optical element of stress-birefringent material by moving the wedge, in response to the action of a drive system for moving the wedge, whereby by controlling the stressing device to move the at least one wedge the polarization state of light passing through optical channels containing stress birefringent material affected by moving the wedge is set or changed.

41. Fly's eye condenser according to claim 39, which, in order to arrange the optical groups in a raster, includes at least one carrier grid which has at least one wedge acting as the stressing element of the stressing device.
